(19) United States
(12) Patent Application Publication
(10) Pub. No.: US 2008/0231010 A1
(43) Pub. Date: Sep. 25, 2008

(54) Motor Vehicle Chassis

(76) Inventors: Reinhard Buhl, Bohmte (DE); Wolfgang Kleiner, Wagenfeld (DE)

Correspondence Address: MCGLEW & TUTTLE, PC, P.O. BOX 9227, SCARBOROUGH STATION, SCARBOROUGH, NY, 10510-9227, US

(21) Appl. No.: 11/996,815

(22) PCT Filed: Jul. 28, 2006
(86) PCT No.: PCT/DE2006/001315

§ 371 Date: Jan. 25, 2008

(30) Foreign Application Priority Data
Jul. 28, 2005 (DE) 10 2005 035 913.2

(51) Int. Cl. B60G 7/00; B60G 3/06; F16C 11/06; B62D 7/16

(52) U.S. Cl. 280/124.11; 280/124.1; 403/74

(57) ABSTRACT

A motor vehicle chassis has, on at least one axle, a control arm (7) guiding and/or carrying a wheel each and at least one wheel carrier (3) connected movably to this and to the wheel (5). A connection is provided between the control arm (7) and the wheel carrier (3) including a joint and/or bearing arrangement (8) designed such that at least one pin (12), which points rigidly upward from the wheel carrier (3), and which is held at a mount associated with the control arm (7) in an articulated manner, is associated with the wheel carrier (3).

### CROSS REFERENCE TO RELATED APPLICATIONS

This application is a United States National Phase application of International Application PCT/DE2006/001315 and claims the benefit of priority under 35 U.S.C. § 119 of German Application 10 2005 035 913.2 filed Jul. 28, 2005, the entire contents of which are incorporated herein by reference.

### FIELD OF THE INVENTION

The present invention pertains to a motor vehicle chassis according as to a joint and/or bearing arrangement therefor.

### BACKGROUND OF THE INVENTION

It is known that a joint arrangement is fixed at the wheel-side end of the suspension arm in motor vehicle chassis for connecting, for example, a lower suspension arm to the wheel carrier being held thereon, the joint arrangement being mounted for this purpose in a fixed manner on a mounting plate provided with three elongated holes. This [mounting plate] can then be screwed to the end of the suspension arm, and a possibility of adjustment is obtained by means of the elongated holes.

The pivot pin projecting upward from the mounting plate passes through the wheel carrier and can be secured above same by means of a screw connection.

The assembly effort is consequently great. The screw connection is poorly accessible because it is located on the side of the wheel carrier facing the hub. This is especially true in the case of driven axles, in which the drive shaft with the gasket surrounding it is in close contact with the extension arm of the wheel carrier, which said extension arm is connected to the suspension arm. In particular, a later replacement of the joint is thus made rather difficult.

In addition, the extension arm of the wheel carrier, which extension arm is connected to the suspension arm, must be designed in this arrangement such that it is at a sufficiently great distance radially from the hub in order to make it possible to access the screw connection at all. Due to the extension arm being arranged at a sufficiently great distance radially, the extension arm is, however, located very closely adjacent to the wheel flange, so that space problems arise here as well.

### SUMMARY OF THE INVENTION

The basic object of the present invention is to achieve an improvement of a motor vehicle chassis.

Due to the fact that a rigidly outwardly pointing pin, which is held at a mount associated with the control arm, is associated with the wheel carrier, the fastening between the wheel carrier and the suspension or the wheel axle is displaced radially outwardly. No fastening means is necessary now in the space between the wheel carrier and the hub, and no intervention is needed here during the assembly or disassembly. The extension arm of the wheel carrier than thus move closer to the hub, and floating is increased relative to the wheel flange.

When a fastening means, which secures the connection of the outwardly pointing end of the pin to the control arm, for example, a nut, which can be placed on the pin and braces same radially, can be attached to the outwardly pointing end of the pin, this [fastening means] is readily accessible from the outside, so that not only the assembly, but also the disassembly, performed for maintenance purposes, are facilitated. After removing the readily accessible nut, the suspension arm, if it is a lower suspension arm, which the pin faces with a downwardly pointing component from the top, drops down, so that, for example, a sleeve joint fastened to this for receiving the pin, can be replaced in a simple manner.

Depending on its design, the pin may be connected rigidly to the wheel carrier or made integrally in one piece therewith.

The present invention can be used especially advantageously on a McPherson axle with the wheel drive shafts passing through the wheel carrier above the pin connecting the wheel carrier to the suspension arm, where the above-mentioned problems of the conventional solution become especially apparent and the present invention therefore shows very great advantages.

If the rigid pin of the wheel carrier at the suspension arm is received in a sleeve joint, the forces occurring can be absorbed. The joint can be stressed axially as well as radially on bending and it permits, moreover, an optimal orientation.

The sleeve joint very advantageously has an eccentric hole, so that the transverse distance of the mount of the pin can be set variably by rotating this hole. This setting can be performed with the wheel mounted and fixed by tightening the only one fastening means securing the pin at the suspension arm. The effort needed for setting is thus minimized.

Other advantages and features of the present invention appear from the exemplary embodiments of the subject of the present invention, which are shown in the drawings and will be described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic general drawing of a joint and/or bearing arrangement according to the present invention at a driven wheel of a motor vehicle chassis;

FIG. 2 is a detail view, approximately corresponding to detail II in FIG. 1, with the suspension arm removed;

FIG. 3 is an exploded view of the connection site in FIG. 2 with the joint cut open in the suspension arm;

FIG. 4 is a top view of the joint accommodated in the suspension arm;

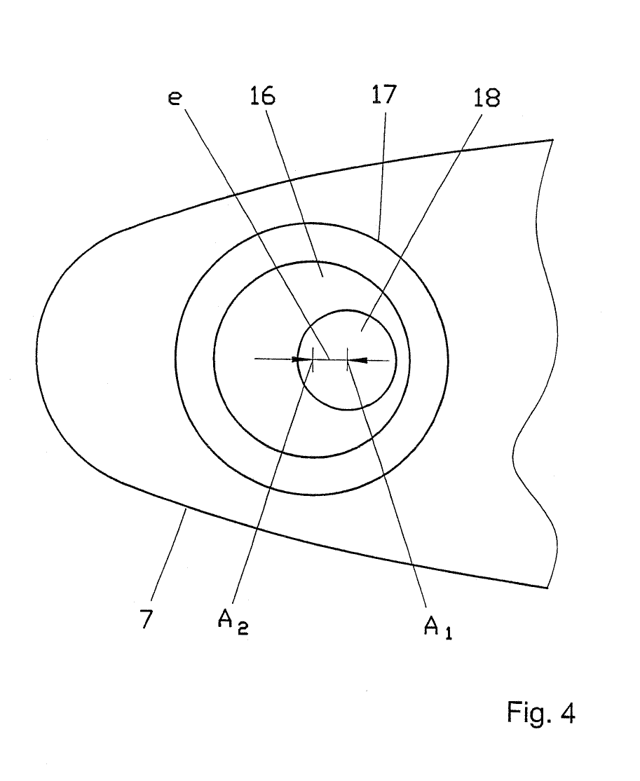

FIG. 5 is a sectional view of various pin shapes;

FIG. 6 is a perspective exploded view of a suspension arm with a sleeve joint held thereon at the extending end and with a pin of the wheel carrier, which is received thereon;

FIG. 7 is a similar perspective exploded, but simplified view, as compared to FIG. 6, but showing the right-hand wheel carrier; and

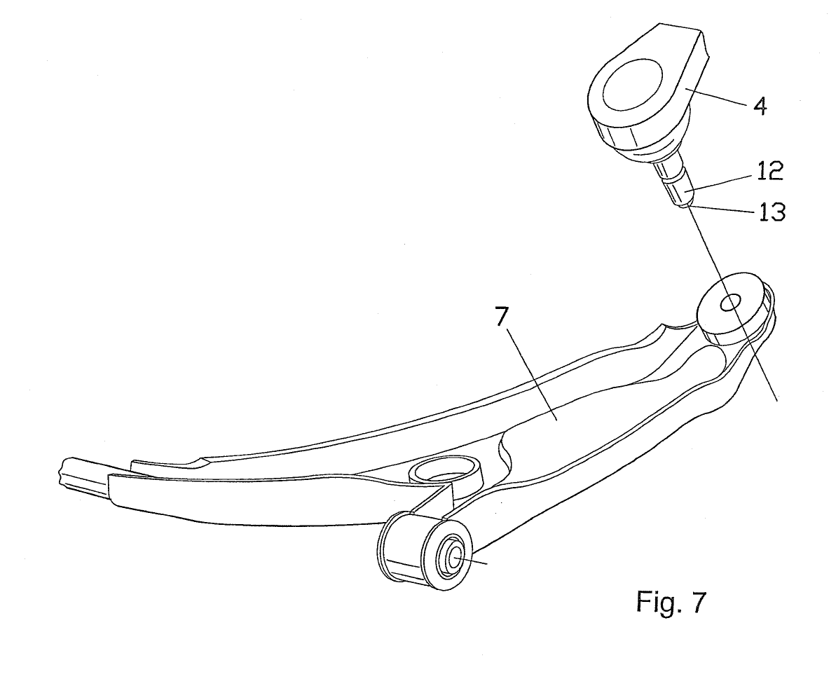

FIG. 8 is a comparative view of the prior-art concept and the concept according to the present invention.

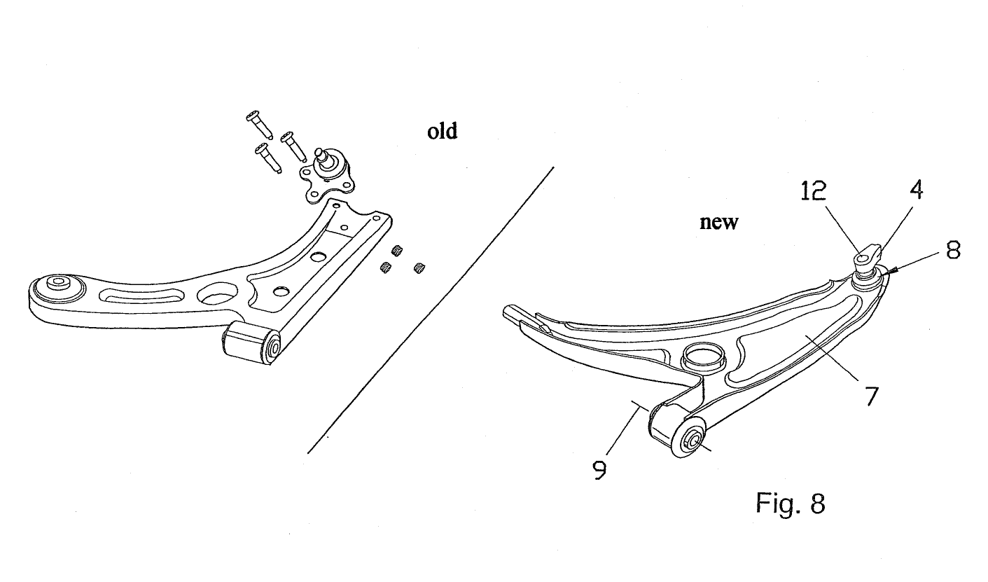

### DESCRIPTION OF THE PREFERRED EMBODIMENTS

Referring to the drawings in particular, The drawings show as an example a detail of a chassis with an axle in McPherson arrangement 1, in which a spring strut 3 acts on the upper end of a wheel carrier 2, and an extension arm 4 is provided at the lower end of the wheel carrier 2, which said extension arm points with one component in the direction of the transverse center of the vehicle and via which the wheel carrier 3 is connected to a suspension arm 7, which carries or at least guides the wheel 5, indicated here by the rim 6, via a joint and/or bearing arrangement 8. The suspension arm 7 is designed here as a so-called triangular suspension arm and is articulated to the body such that it can be pivoted about an axis 9 extending at least nearly along the vehicle.

A drive shaft 10, which is in turn surrounded by a gasket 11, passes through the wheel carrier 3.

Instead of a McPherson arrangement, it is possible to use other geometries as well. For example, it is also possible to provide an arrangement with an upper suspension arm 7 and a lower suspension arm 7. An exemplary embodiment with only one lower suspension arm 7 will be described below.

At least one pin 12, and exactly one pin in the drawing, which points rigidly outwardly from the wheel carrier, and which points with one component downwardly towards the suspension arm 7 and is received at this in the joint arrangement 8, is associated with the wheel carrier 3.

The pin 12 may be rigidly connected to the wheel carrier, for example, secured via a press fit or weld seam in a recess made there. As an alternative, the pin 12 may also be made integrally in one piece with the wheel carrier 3. In any case, the unit comprising the wheel carrier 3 and the pin 12 can be delivered to the assembly line in a completely mounted state.

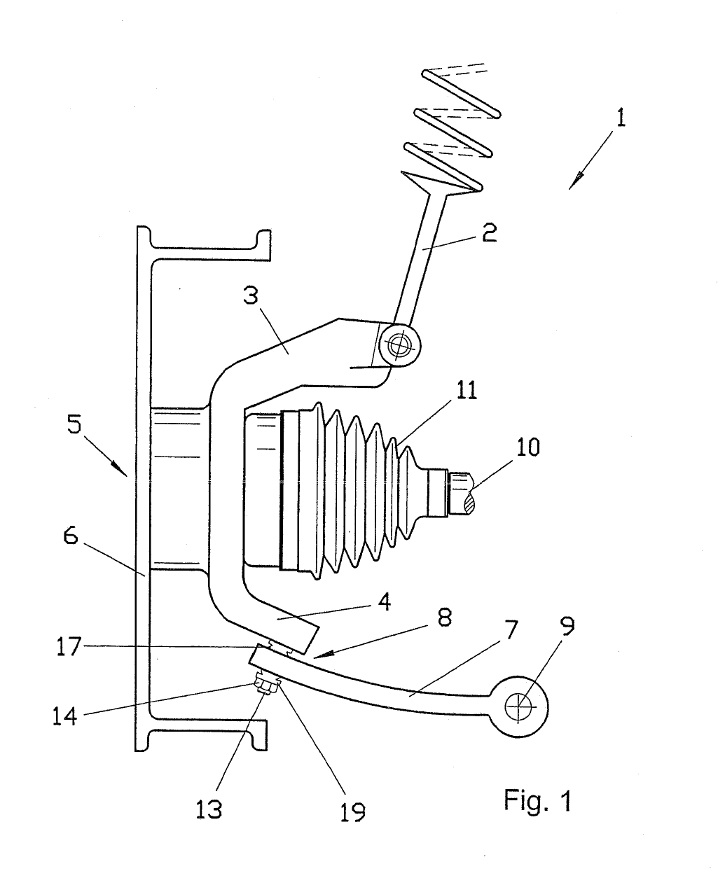

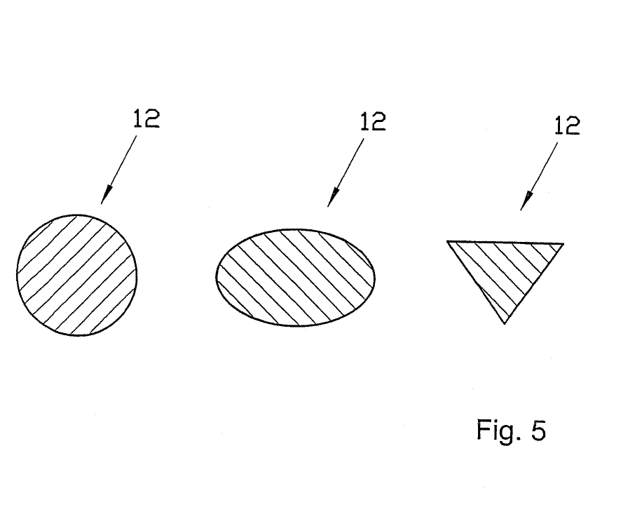

Depending on the geometry, the pin 12 may have a cross-sectional shape deviating from a symmetry of rotation, for example, as is shown in FIG. 5, an elliptical or triangular cross section, to counteract a preferred direction of the stress. Also, unlike as shown in FIG. 1, the pin 12 does not have to have a uniform cross section over its entire length but it may, for example, also taper conically, hyperbolically or parabolically or be stepped. The pin 12 typically has a length of 4 to 7 cm, depending on the joint arrangement 8 to be accommodated.

In any case, a fastening means 14, which secures the connection of the pin 12 to the suspension arm 7, can be attached to the outwardly pointing end 13 of the pin 12. An external thread, which can be secured by means of the nut 14, is provided here at the pin end 13.

In the mounted state, the pin 12 passes through the suspension arm, 7, so that the fastening element 14 can be attached to the pin 12 on the side located on the other side of the suspension arm 7, i.e., on the underside of the suspension arm 7 here. A fastening means, which would have to be introduced into the space between the extension arm 4 and the drive shaft 11, can thus be done away with altogether. The extension arm 4 can thus be moved closer to the wheel hub by several mm compared to prior versions, as a result of which the floating is increased by the corresponding amount in relation to the wheel flange.

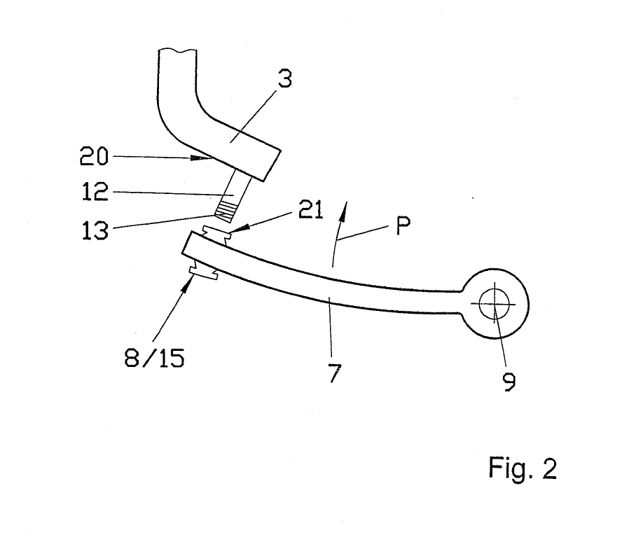

Since the nut 14 is attached radially on the outside in relation to the wheel axle, it is accessible in a simple manner. This also facilitates the disassembly, during which the suspension arm 7 pivots downward about its axis 9 under its own weight after removing the nut 14 and must be correspondingly pivoted upward in the direction of arrow P for mounting and must be secured from below by means of the readily accessible nut 14 (FIG. 2).

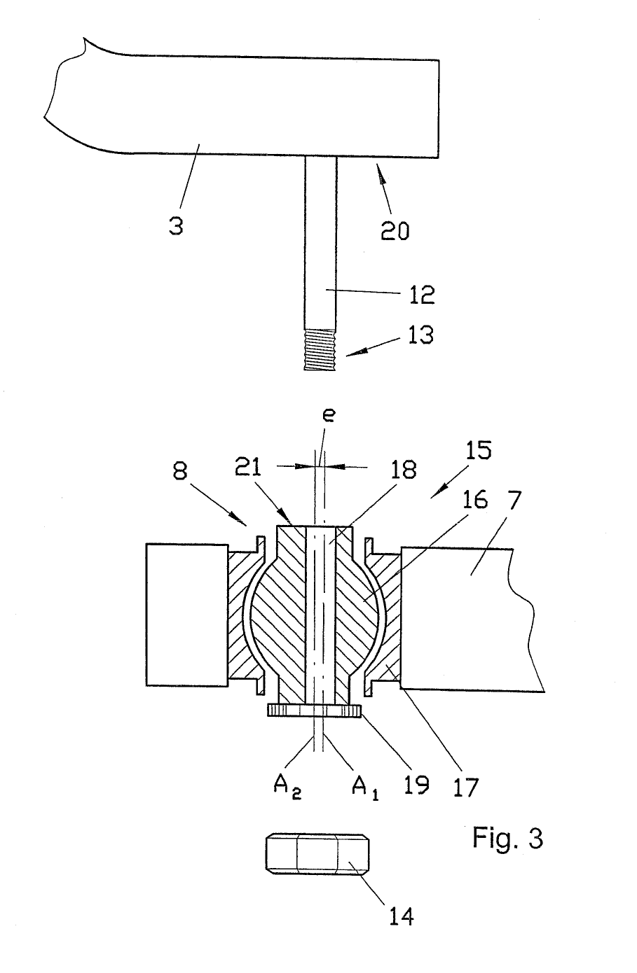

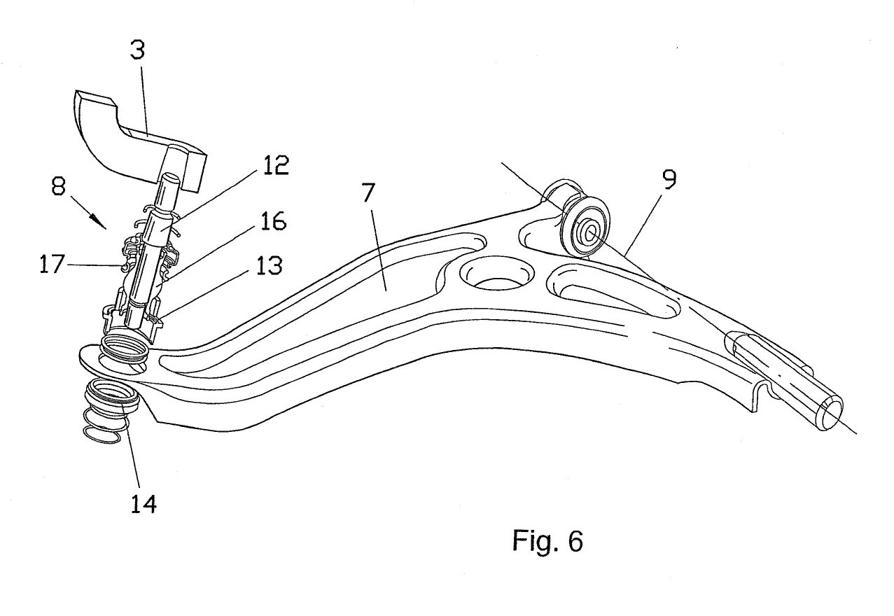

As can be determined, for example, from FIG. 3, the pin 12 can be accommodated at the suspension arm 7 in a joint arrangement 8 designed as a sleeve joint 15, whose joint shell 17 is pressed into the suspension arm 7 or is welded in, for example, with a circular weld seam. In the embodiment according to FIG. 6, the sleeve joint 15 is located between the wheel carrier 3 and the suspension arm 7 and is also secured under it by a union nut 14. The exact arrangement of the sleeve joint therefore depends on the particular geometries in the vehicle. It is also possible, for example, to mount the sleeve joint 15 on an adapter, which is to be screwed, for example, to the suspension arm 7 by means of elongated holes. In any case, the joint 15 is rigidly connected to the suspension arm 7 after it has been mounted.

To make it possible to compensate manufacturing tolerances of the suspension arm, of its articulation, of the body or of other parts, the sleeve joint 15 has an eccentric through hole 18 with a central axis Al for receiving the pin 12. The central axis Al is offset in parallel by the eccentricity e in relation to the central axis A2 of the joint body 16. As a result, it becomes possible during mounting to connect the wheel carrier 3 first to the suspension arm 7 by passing the pin 12 through the hole 18 and subsequently performing a fine adjustment, especially in the transverse direction of the vehicle, in this connected position, in which the orientation of the wheel can be easily checked by inspection. The joint body 16 of the sleeve joint 15 has for this, at its lower end here, a hexagon insert bit 19 or another possibility of attachment for a tool, with which the joint body 16 can be rotated until the set camber corresponds to the preset set value. This position can then be fixed by attaching the nut or another fastening means 14 to the pin end 13 passing through downwardly and tightening it, as a result of which the lower edge 20 of the extension arm 4 is rigidly braced with the upper edge 21 of the joint body 16.

The use of an eccentric and settable joint arrangement 8 facilitates mounting and makes it possible, despite the possibility of setting, to tighten only one fastening means 14 or to remove only one fastening means 14 for disassembly, which means a considerable facilitation of work, for example, compared to an adapter solution with a plurality of elongated holes and, moreover, a weight reduction.

The joint 15 can be stressed both axially and radially on bending.

While specific embodiments of the invention have been shown and described in detail to illustrate the application of the principles of the invention, it will be understood that the invention may be embodied otherwise without departing from such principles.

1-15. (canceled)

16. A motor vehicle chassis comprising:
an axle and a wheel;
a wheel carrier;
a control arm guiding and/or carrying said wheel and said wheel carrier, said control arm being movably connected to said wheel carrier and to said wheel;
a connection between said control arm and said wheel carrier, said connection comprising a joint and/or bearing arrangement with at least one pin associated with said wheel carrier, said pin extending rigidly upward from said wheel carrier, and a mount associated with said control arm, said pin being held on said mount in an articulated manner.

17. A motor vehicle chassis in accordance with claim 16, further comprising: a fastening means for securing the connection between said pin and said control arm, said fastening means being attached to said outwardly pointing end of said pin.

18. A motor vehicle chassis in accordance with claim 16, wherein said pin is connected to said wheel carrier.

19. A motor vehicle chassis in accordance with claim 16, wherein said pin is made integrally in one piece with said wheel carrier.

20. A motor vehicle chassis in accordance with claim 16, wherein said control arm is a suspension arm, and said pin extends with a downwardly pointing component from a top of said suspension arm.

21. A motor vehicle chassis in accordance with claim 16, further comprising: a fastening means for securing the connection between said pin and said control arm, wherein said control arm is a suspension arm and said pin passes through said suspension arm to a first side of said suspension arm in a mounted position and said fastening element is attached to an outwardly extending end of said pin on a second side, said second side being opposite said first side.

22. A motor vehicle chassis in accordance with claim 16, wherein said control arm is a suspension arm and said axle is a McPherson axle with a drive shaft passing through said wheel carrier above said pin connecting said wheel carrier to said suspension arm.

23. A motor vehicle chassis in accordance with claim 16, wherein said pin is received at said suspension arm in a sleeve joint.

24. A motor vehicle chassis in accordance with claim 23, wherein said sleeve joint has an eccentric hole.

25. A motor vehicle chassis in accordance with claim 24, further comprising: a fastening means for securing the connection between said pin and said control arm, wherein said eccentric hole has an eccentricity that can be set and can be fixed by said fastening element for securing said pin on said suspension arm.

26. A motor vehicle chassis in accordance with claim 16, further comprising: a fastening means for securing the connection between said pin and said control arm, wherein said control arm is a suspension arm and wherein for mounting, said suspension arm is pivoted to said wheel carrier with said pin mounted thereon and said fastening means is mounted or removed from the other side of the plane in which said suspension arm extends.

27. A joint and/or bearing arrangement for a motor vehicle chassis, the joint comprising:
a joint pin associated with a wheel carrier, said pin extending rigidly upward from said wheel carrier;
a mount associated with a control arm part for guiding and/or carrying a wheel and a said wheel carrier, said control arm being part being movably connected to said wheel carrier and to said wheel with said pin being held on said mount in an articulated manner.

28. A joint and/or bearing arrangement in accordance with claim 27, wherein said pin being held on said mount in an articulated manner is adapted for being stressed both axially and radially on bending.

29. A joint and/or bearing arrangement in accordance with claim 27, wherein said pin has a cross-sectional shape deviating from a rotational symmetry to counteract a preferred direction of stress.

30. A motor vehicle comprising:
a chassis and/or steering parts;
an axle and a wheel;
a wheel carrier;
a control arm connected to said chassis and/or steering parts, said control arm for guiding and/or carrying said wheel and said wheel carrier, said control arm being movably connected to said wheel carrier and to said wheel;
a connection between said control arm and said wheel carrier, said connection comprising a joint and/or bearing arrangement with at least one pin associated with said wheel carrier, said pin extending rigidly upward from said wheel carrier, and a mount associated with said control arm, said pin being held on said mount in an articulated manner.

31. A motor vehicle in accordance with claim 30, further comprising: a fastening means for securing the connection between said pin and said control arm, said fastening means being attached to said outwardly pointing end of said pin.

32. A motor vehicle chassis in accordance with claim 31, wherein said control arm is a suspension arm and said pin passes through said suspension arm to a first side of said suspension arm in a mounted position and said fastening element is attached to an outwardly extending end of said pin on a second side, said second side being opposite said first side.

33. A motor vehicle chassis in accordance with claim 30, wherein said control arm is a suspension arm and said axle is a McPherson axle with a drive shaft passing through said wheel carrier above said pin connecting said wheel carrier to said suspension arm.

34. A motor vehicle chassis in accordance with claim 31 ,wherein said pin is received at said suspension arm in a sleeve joint, wherein said sleeve joint has an eccentric hole with an eccentricity that can be set and can be fixed by said fastening element for securing said pin on said suspension arm.

35. A motor vehicle chassis in accordance with claim 31, wherein said pin is one of connected to said wheel carrier and is made integrally in one piece with said wheel carrier.
